(19) United States
(12) Patent Application Publication
(10) Pub. No.: US 2008/0032664 A1
(43) Pub. Date: Feb. 7, 2008

(54) Handheld apparatus with detachable audio device

(76) Inventors: Ping-Hui Chou, Taipei City (TW); Teng-Lung Chang, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/488,846

(22) Filed: Jul. 19, 2006

(51) Int. Cl. H04B 1/08

(52) U.S. Cl. 455/348

(57) ABSTRACT

The present invention relates to a handheld apparatus with a detachable audio device. By making the audio device of the handheld apparatus a detachable audio device, the handheld apparatus connects to the audio device through a card slot to make the audio device detachable from the card slot for being an external audio device with wireless interface. In addition, the handheld apparatus installs a first connector in the card slot to connect to a second connector of the audio device for making the handheld apparatus charge the audio device. Thereby, using time of the audio device is extended due to charging from the handheld apparatus. The present invention combines a handheld apparatus and an audio device with wireless transmission functionality into an integral apparatus, which can be used in the whole. Alternatively, the audio device can be used individually to converse or perform operations related to the audio device.

### FIELD OF THE INVENTION

The present invention relates generally to a handheld apparatus, and particularly to a handheld apparatus with a detachable audio device to make the audio device detached from the handheld apparatus and be an external audio device with wireless transmission.

### BACKGROUND OF THE INVENTION

Presently, handheld apparatuses have been applied extensively by people. Cell phones, personal digital assistants (PDAs), laptop or notebook computers, and portable multimedia players (PMPs), for example, are handheld apparatuses with which people are familiar and use frequently. In regard to cell phones, almost all people own their cell phones; for general working people, in addition to being used as notebooks, PDAs can connect to the internet via wirelessly-networked hotspots or through mobile networking services. Furthermore, modern cell phones can also connect to the internet by means of General Packet Radio Service (GPRS) or Wireless Application Protocol (WAP). Thereby, not only computer systems can provide the ability of connecting to the internet, but cell phones can also connect to the internet via mobile internet.

Cell phones bring people maximum convenience in that they can communicate to others at any time and place. If people somehow cannot talk to a person whom they want to talk to, Short Message Service (SMS) can be used for communication. While using cell phones, people may need to handle other business simultaneously owing to the need of the works. For example, with accompanying persons, personnel who are responsible for external affairs can only drive cars and answer to the phones at the same time, which, for current laws, is illegal, and is prone to danger. Consequently, the hand-free function of cell phones is developed. In the beginning, the hand-free function of cell phones follows the hand-free method in public switched telephone network (PSTN) telephones, which drives speakers of the cell phones to increase output volume in order to make users of the cell phones hear voices without the need of picking phones close to their ears.

However, cell phones can be used at any time and place, thereby the increased output volume by speakers makes conversational contents public. In addition, the increased output volume may usually be too noisy to be heard with clarity. The noises will annoy environment as well. Furthermore, the microphones used need, thereby, to be high-sensitivity microphones to receive users' voices. For convenience of using phones and for clarity of conversational contents, earphones are developed nowadays. In the beginning, earphones are connected to the cell phones via transmission lines and connectors. However, due to length limitation of the transmission lines, the cell phones need to be carried with users. Owing to the deficiency, wireless earphones, particularly Bluetooth earphones, which are compatible with the third-generation (3G) mobile communication technology, are developed. For users of cell phones, wireless Bluetooth earphones make people need not to carry cell phones with them. Phone communications can be performed within the signal transmission and receiving ranges of wireless Bluetooth.

Consequently, a user with a wireless earphone to the cell phone can free his hand originally occupied by the cell phone, and needs not to carry the cell phone with him. Besides, Bluetooth wireless transmission further provides a charging function for charging exhausted Bluetooth wireless earphones via Bluetooth transmission, and thereby the earphones can go on being used.

Owing to the occurred problems on handheld apparatuses such as cell phones and PDAs as described above, the present invention, thereby, provides a handheld apparatus with a detachable audio device. In the present invention, an audio device is adapted to a handheld device through a card slot. Accordingly, the audio device can be detached to be an external audio device with wireless transmission.

### SUMMARY

The purpose of the present invention is to provide a handheld apparatus with a detachable audio device. A first wireless module is adapted to a handheld apparatus. An audio device with a second wireless module is adapted to the handheld apparatus through a card slot, such that the audio device can detach from the card slot. Hence, users can carry the audio device with them without the need of carrying the handheld apparatus. Microphones, speakers, or combination of the both need not to be adapted additionally to the handheld apparatus, thereby electrical power can be saved.

The present invention provides a handheld apparatus with a detachable audio device, which comprises a handheld apparatus and an audio device. The handheld apparatus includes a first connector, a first wireless module, and a card slot; the audio device includes a second connector, a second wireless module, and an audio input/output module. When the audio device is adapted to the card slot, the first connector connects with the second connector to charge the audio device from the handheld apparatus. When the audio device is detached from the card slot, signals are transmitted via the first wireless module and the second wireless module, so that the handheld apparatus and the audio device can transmit signals to each other. The present invention applies to handheld apparatuses such as cell phones or PDAs, to which a Bluetooth earphone connects externally through a card slot in order to share microphone, speakers, or combination of the both among the cell phones, the PDAs, and the Bluetooth earphone. Besides, the Bluetooth earphone can be used individually by detaching it from the card slot.

In order to make the structure and characteristics as well as the effectiveness of the present invention to be further understood and recognized, the detailed description of the present invention is provided as follows along with preferred embodiments and accompanying figures.

### BRIEF DESCRIPTION OF THE DRAWINGS

FIG. 1A is a structural schematic diagram according to a preferred embodiment of the present invention;

FIG. 1B is a block diagram of partial structure according to a preferred embodiment of the present invention;

FIG. 1C is a block diagram of partial structure according to a preferred embodiment of the present invention;

FIG. 2A is a block diagram of partial structure according to another preferred embodiment of the present invention;

FIG. 2B is a block diagram of partial structure according to another preferred embodiment of the present invention;

FIG. 2C is a block diagram of partial structure according to another preferred embodiment of the present invention;

FIG. 2D is a block diagram of partial structure according to another preferred embodiment of the present invention;

FIG. 2E is a block diagram of partial structure according to another preferred embodiment of the present invention;

FIG. 2F is a block diagram of partial structure according to another preferred embodiment of the present invention;

FIG. 2G is a block diagram of partial structure according to another preferred embodiment of the present invention;

FIG. 2H is a block diagram of partial structure according to another preferred embodiment of the present invention;

FIG. 2I is a block diagram of partial structure according to another preferred embodiment of the present invention;

FIG. 2J is a block diagram of partial structure according to another preferred embodiment of the present invention;

FIG. 2K is a block diagram of partial structure according to another preferred embodiment of the present invention;

FIG. 3 is a structural schematic diagram according to another preferred embodiment of the present invention; and

FIG. 4 is a structural schematic diagram according to another preferred embodiment of the present invention.

### DETAILED DESCRIPTION

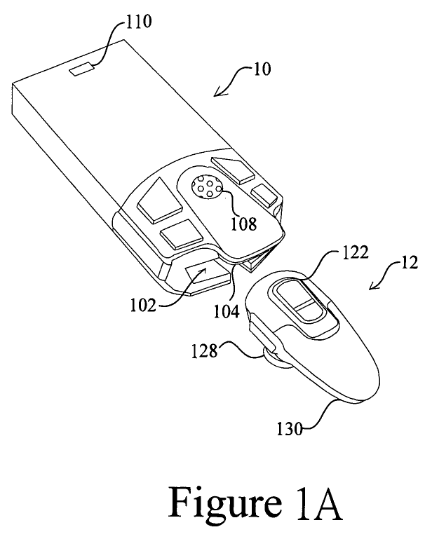

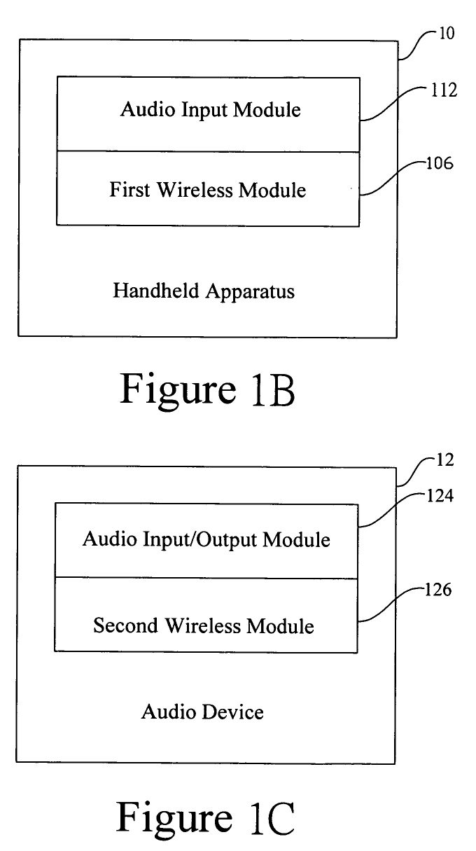

First, FIG. 1A is a structural schematic diagram according to a preferred embodiment of the present invention. As shown in the figure, the present invention is a handheld apparatus with a detachable audio device, which comprises a handheld device 10 and an audio device 12. A card slot 102, a first connector 104, a speaker 108, and an audio receiving unit 110 are adapted to one side of the handheld device 10; a second connector 122, a speaker 128, and a microphone 130 are adapted to one side of the audio device 12. The first connector 104 is adapted to one inner side of the card slot 102, so that when the handheld apparatus 10 connects to the audio device 12, it connects to the second connector 122 at the same time. In addition, in terms of connection of the first connector 104 and the second connector 122, the handheld apparatus 10 and the audio device 12 are electrically connected. The speaker 108 provides voices with increased volume for the handheld apparatus 10. The audio receiving unit 110 converts voices into a voice signal for inputting to the handheld apparatus 10. As shown in FIGS. 1B and 1C, a first wireless module 106 and an audio input module 112 are adapted inside of the handheld apparatus 10, and an audio input/output module 124 and a second wireless module 126 are adapted to the audio device 12.

By means of the first wireless module 106 and the second wireless module 126, the handheld apparatus 10 and the audio device 12 can transmit signals to each other. In addition, the audio input/output module 124 converts a first signal received by the second wireless module 126 to a first voice signal for providing the speaker 128 to output voices corresponding to the first voice signal. Furthermore, a second voice signal corresponding to the input voice to the microphone 130 is input to the audio input/output module 124 for converting the second voice signal to a second signal, which is then transmitted to the first wireless module 106 by the second wireless module 126 for further processes by the handheld apparatus 10. The card slot 102 of the handheld apparatus 10 is provided for the audio device 12. When the audio device 12 plugs into the handheld apparatus 10 through the card slot 102 and the second connector 122 in the audio device 12 connects with the first connector 104 adapted in the card slot 102, the handheld apparatus 12 and the audio device 12 are electrically connected for providing the handheld apparatus 12 to charge the audio device 12. Moreover, when the audio device 12 detaches from the card slot 102 of the handheld apparatus 10, the wireless transmission interface between the first wireless module 106 and the second wireless module 126 will be used to transmit and receive signals between the handheld apparatus 10 and the audio device 12. The wireless transmission interface makes the handheld apparatus 10 receive and transmit voice signals to the audio device 12. Likewise, it also makes the audio device 12 receive and transmit voice signals to the handheld apparatus 10.

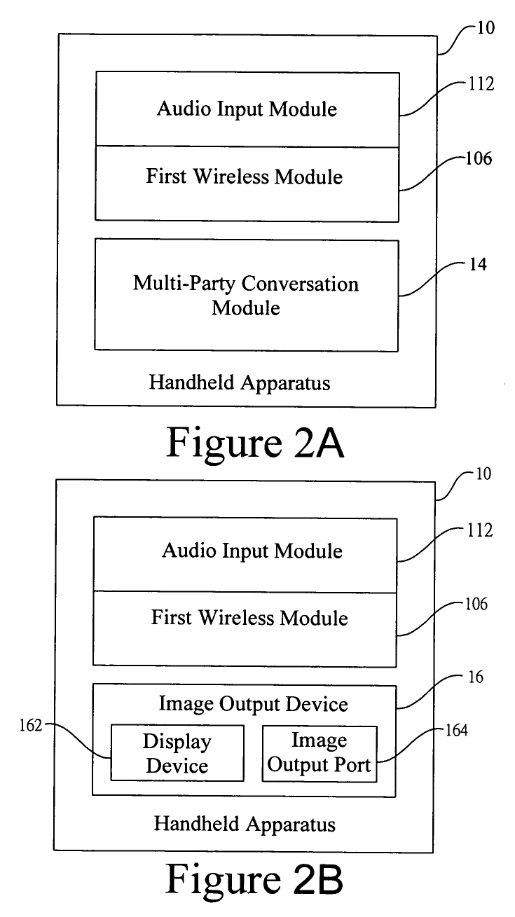

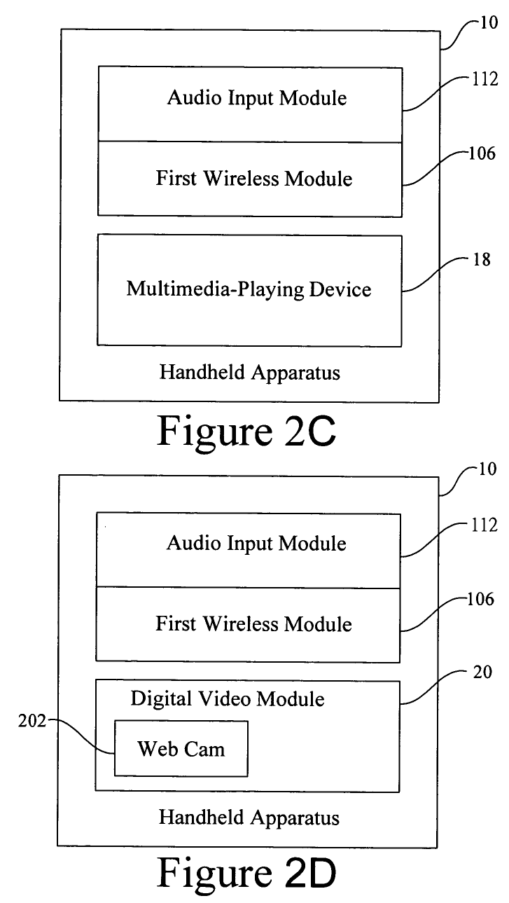

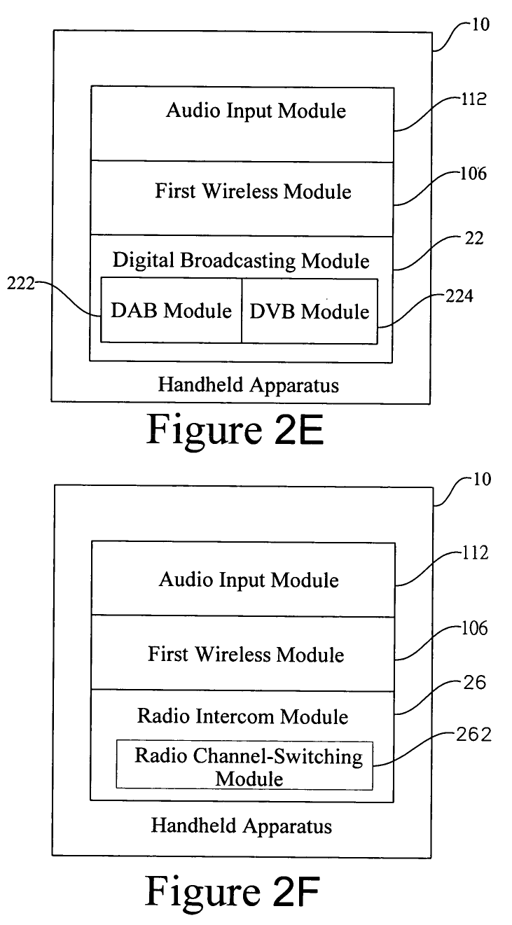

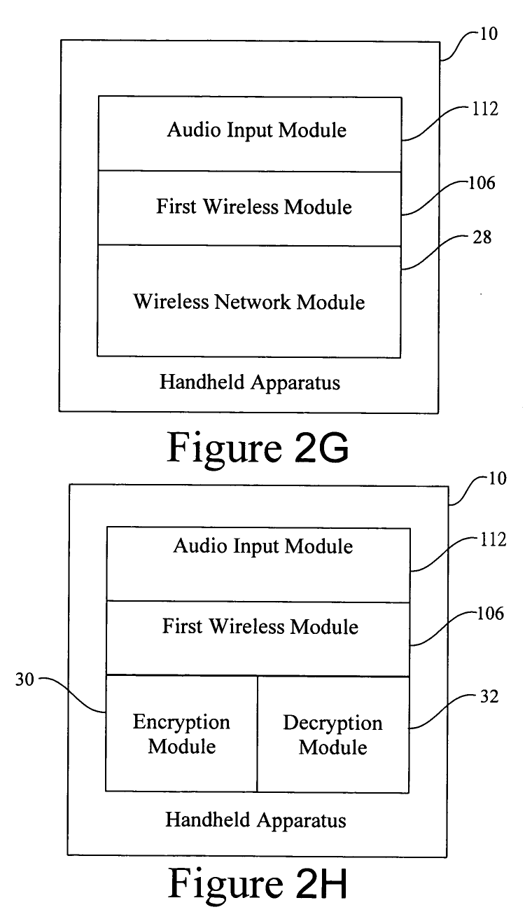

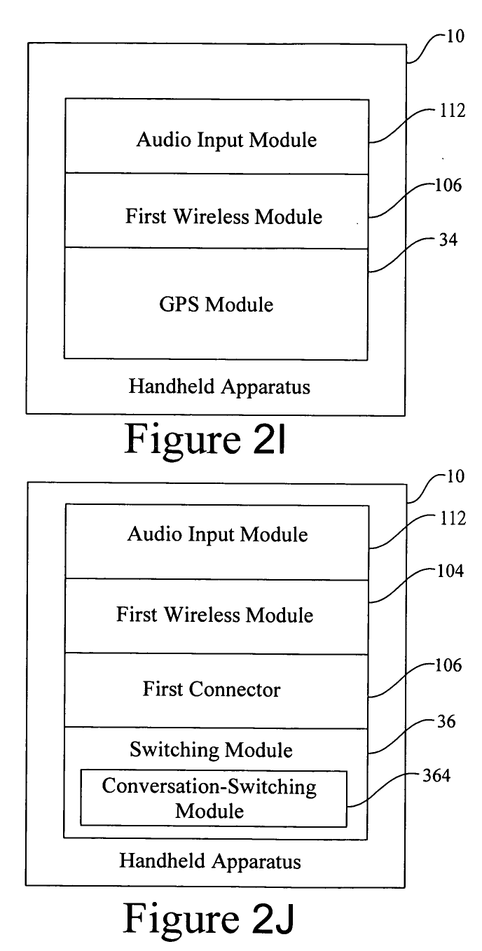

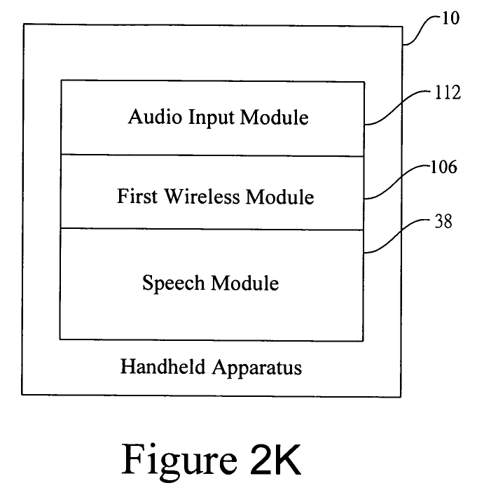

Please refer to FIG. 2A to FIG. 2K, which are block diagrams of partial structure according to another preferred embodiment of the present invention. As shown in FIG. 2A to FIG. 2K, the difference between FIG. 1B and FIG. 2A is that the handheld apparatus 10 in FIG. 2A further installs a multi-party conversation module 14; the difference between FIG. 1B and FIG. 2B is that the handheld apparatus 10 in FIG. 2A further installs an image output device 16; the difference between FIG. 1B and FIG. 2C is that the handheld apparatus 10 in FIG. 2A further installs a multimedia-playing device 18; the difference between FIG. 1B and FIG. 2D is that the handheld apparatus 10 in FIG. 2A further installs a digital video module 20; the difference between FIG. 1B and FIG. 2E is that the handheld apparatus 10 in FIG. 2A further installs a digital broadcasting module 22; the difference between FIG. 1B and FIG. 2F is that the handheld apparatus 10 in FIG. 2A further installs a wireless conversation module 26; the difference between FIG. 1B and FIG. 2G is that the handheld apparatus 10 in FIG. 2A further installs a wireless network (namely, Wireless Fidelity, WiFi) module 28; the difference between FIG. 1B and FIG. 2H is that the handheld apparatus 10 in FIG. 2A further installs a encryption module 30 and a decryption module 32; the difference between FIG. 1B and FIG. 2I is that the handheld apparatus 10 in FIG. 2A further installs an image output device 16 and a Global Positioning System (GPS) module 34; the difference between FIG. 1B and FIG. 2J is that the handheld apparatus 10 in FIG. 2A further installs a switching module 36; the difference between FIG. 1B and FIG. 2K is that the handheld apparatus 10 in FIG. 2A further installs a speech module 38.

In addition to the fundamental model of circuit modules in the handheld apparatus 10 according to the present invention shown in FIG. 1B, the handheld apparatus 10 further installs other circuit modules to equip itself with varied functionality. Thereby, users can acquire more convenience by the handheld apparatus 10. In the following, the functions provided by various modules of the handheld apparatus 10 will be described. As shown in FIG. 2A, the multi-party conversation module 14 provides the handheld apparatus 10 the ability to receive conversation signals transmitted by multiple people using different communication protocols or an identical communication protocol simultaneously. By installing a conversation-switching module 132 in the audio device 12, a user can converse with multiple other users using different communication protocols simultaneously. For example, a user can use the handheld device 10 to converse with multiple other users using Skype and PSTN interfaces simultaneously. The multi-party conversation module 14 also provides the handheld apparatus 10 the ability to converse with multiple people using an identical communication protocols simultaneously. For example, a user can use the handheld device 10 to converse with multiple other users using mobile communication interface simultaneously.

As shown in FIG. 2B, the image output device 16 includes a display device 162 and an image output port 164. The display device 162 is a display device such as a liquid-crystal display (LCD) panel or organic light-emitting diodes (OLEDs); the image output port 164 is an analog video interface (AVI) output port or a digital visual interface (DVI) output port. Thereby, the handheld apparatus 10 can display received or stored images on the display device 162, and can output received or stored images to external display devices through the image output port 164. As shown in FIG. 2C, the handheld apparatus 10 further install a multimedia-playing device 18, which supports a plurality of multimedia formats, for example, Motion Picture Experts Group Audio Layer III (MP3), Waveform audio format (WAV), or Digital Video Disc (DVD) multimedia format. Hence, the handheld apparatus 10 can use multimedia, such as digital audio, digital audio/video (AV), at any time and place. In addition, the handheld apparatus 10 can support AV playing software via the multimedia-playing device 18. Thereby, the handheld apparatus 10 can play multimedia audio/video by using AV playing software.

As shown in FIG. 2D, the handheld apparatus 10 further install a digital video module 20, which includes a web cam 202 to make the handheld apparatus 10 take motion pictures via the web cam 202. Furthermore, the images taken by the web cam 202 can be output real-time through the communication interface of the handheld apparatus 10. For example, video conversation of the 3G mobile communication interface executes synchronously the imaging function of a web cam and the conversation function of a cell phone to make video and audio transmit synchronously, and thereby people in phone conversation can communicate as if they were face to face. Besides, the web cam 202 further includes the function of digital cameras. Thus, the handheld apparatus 10 can be further used as a digital camera to take digital pictures.

As shown in FIG. 2E, the digital broadcasting module 22 includes a Digital Audio Broadcasting (DAB) module 222 and a Digital Video Broadcasting (DVB) module 224. Digital broadcasting is a next-generation broadcasting technology, which can broadcast through satellite broadcasting or through terrestrial broadcasting. At present, there are four digital broadcasting standards worldwide including Eureka 147 drawn up by Europe, IBOC drawn up by the US, ISDB-T drawn up by Japan, and DRM drawn up by France, wherein the ISDB-T drawn up by Japan combines audio and video broadcasting standards, while the DRM drawn up by France is a broadcasting standard specifically for amplitude-modulation (AM) digital radio broadcasting. Thereby, the handheld apparatus 10 can receive radio-station broadcasting network, such as FM or AM radio-station broadcasting networks, by converting analog signals to digital signals via the DAB module 222. Because digital audio broadcasting can broadcast multimedia data signals, thereby the DVB module 224 can further provide the function of Digital Multimedia Broadcasting (DMB). Accordingly, the DVB 224 can receive above-three multimedia-audio broadcasts as well as above-one image multimedia-data broadcasts in the same region and from the same channel. Therefore, in addition to make the handheld apparatus 10 receive CD-quality digital audio broadcasts, the DVB module 224 also further make the handheld device 10 receive multimedia data broadcasts, for example, traffic images, weather forecasts, pictures of singers, product catalogs, stock and finance information, and internet web pages.

Next, the handheld apparatus 10 can receive digital video broadcasts, namely digital television broadcasts. Currently, there are three standards for digital television broadcasting including DVB of Europe, ATSC of the US, and ISDB of Japan. Thereby, the handheld apparatus 10 receives digital television broadcasts of different broadcasting standards according to the broadcasting standards that the system providers of digital television broadcasting adopt.

As shown in FIG. 2F, a radio channel-switching module 262 is adapted to the wireless conversation module 26. The handheld apparatus 10 provides radio intercom function like a walkie-talkie via the wireless conversation module 26. A plurality of wireless channels is provided to make a user converse real-time with others in the same channel. The radio channel-switching module 262 provides users of the handheld apparatus 10 the ability of conversing with multiple people, such as in a network chatting room, with different channels by switching to different radio channels.

As shown in FIG. 2G, the wireless network module 28 supports IEEE802.11 wireless local area network (LAN) communication standard. Thereby, the handheld apparatus 10 can connect to a wireless network access point (AP) via the wireless network module 28, which, in turn, will connect the handheld apparatus 10 to the LAN connected by the wireless network AP, and then to a wide area network (WAN), such as the internet. Hence, the apparatus 10 can connect to the WAN according to the operation of users for providing the users with multiple network-related services, for example, sending or receiving emails, browsing web pages, chatting with other users in WAN in terms of real-time communication software such network phones, Skype, MSN Messenger, Yahoo! Messenger, via network protocols or network software.

Then, an embodiment of using the handheld apparatus 10 for phone conversation will be described. When a user uses the handheld apparatus 10 and the audio device 12 to converse with other people, a first network signal will be received from a WAN via the wireless network module 28. The first network signal is transmitted to the second wireless module 126 from the first wireless module 126. The audio input/output module 124 converts the first network signal received by the second wireless module 126 to a first voice signal for making the speaker 128 of the audio device 12 output corresponding voices. Besides, the audio device 12 receives the user's voice as a second voice signal through the microphone 130. Then, the audio input/output module 124 converts the second voice signal to a second network signal to be transmitted to the first wireless module 106 by the second wireless module 126. The second network signal received by the first wireless module 106 outputs to the WAN via the wireless network module 28. In such a way of repeating transmitting and receiving signals, the user can converse with other people.

As shown in FIG. 2H, the handheld apparatus 10 can perform signal encryption and decryption via the encryption module 30 and the decryption module 32. By using signal encryption, the output signals of the handheld apparatus 10 are protected from being captured and stolen. Likewise, by using signal decryption, the received signals of the handheld apparatus 10 are protected as well, preventing the content of the signals being stolen by non-user operation of the handheld apparatus 10. As shown in FIG. 2I, the handheld apparatus 10 displays the location of the handheld apparatus 10 via the image output device 16 and the GPS module 34, by which users can search route maps, confirm their locations, or understand the traffic situation of their locations. As shown in FIG. 2J, the switching module 36 includes a communication-switching module 364. The communication-switching module 364 makes the handheld apparatus 10 be able to switch among communication sources, for example, the switching between Skype and network phone, the switching among Messenger software, PSTN telephone, and cell phone. As shown in FIG. 2K, the handheld apparatus 10 provides a speech-playing function via the speech module 38. When the handheld apparatus 10 receives incoming communication, it will identify the incoming phone numbers or the caller's identity of the incoming communication for the speech module 38 to convert them into speech signals, which are played subsequently by the speaker 108 of the handheld apparatus 10 or by the speaker 128 of the audio device 12. In addition, the methods of identifying incoming calls differ according to different communication protocols. For example, the handheld apparatus 10 identifies callers' identities of Messenger software such as MSN Messenger or Skype, while the handheld apparatus 10 identifies incoming phone numbers or callers' identities of network phones, telephone mode of Skype, or cell phones.

Moreover, the modules in FIG. 2A to FIG. 2K can be integrated in the handheld apparatus 10 to make it multi-functional. Thereby, the handheld apparatus 10 will include a multimedia-playing function, a multi-party conversation function, a mobile internet function, multimedia broadcasting function, encryption function, decryption function, and various switching of the functions described above. Users can browse the internet and converse with other people via the audio device at the same time. Beside, a plurality of number keys and a talk key can be adapted to the audio device 12 to let users make or answer phone calls.

Accordingly, the handheld apparatus with a detachable audio device according to the present invention provides users of cell phones with more using convenience. In addition, because the speaker 128 and the microphone 130 adapt to the audio device 12 only, incoming calls ring from the audio device 12 only, reducing power consumption. The handheld apparatus 10 according to the present invention connects externally to an audio device 12 through a wireless transmission interface, thereby users can make or answer phone calls merely using the audio device 12 through the wireless transmission interface. Besides, the combination of the handheld apparatus 10 and the audio device 12 is a cell phone, which makes users converse with others in the same way of using a normal cell phone.

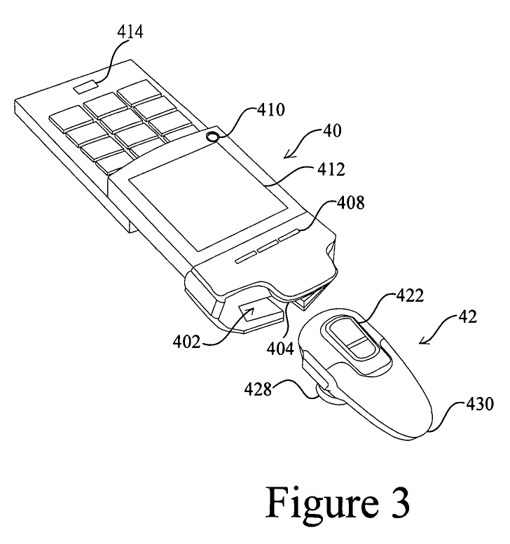

FIG. 3 is a structural schematic diagram according to another preferred embodiment of the present invention. The difference between FIG. 1A and FIG. 3 is that FIG. 3 is an application embodiment of FIG. 1A. The handheld apparatus with a detachable audio device according to the present invention can be applied to a cell phone 40, which can combine with a Bluetooth earphone 42 through a card slot 402. By connecting a first connector (not shown in the figure) and a second connector 422 through the card slot 402, the Bluetooth earphone 42 can be charged. As shown in FIG. 3, the card slot 402, a speaker 408, a web cam 410, a display 412, and an audio receiving unit 414 are adapted to the cell phone 40. The first connector 404 is adapted to the card slot 402. The second connector 422, a speaker 428, and a microphone 430 are adapted to the Bluetooth earphone 42. The cell phone 40 can input voices not only through the microphone 430 of the Bluetooth earphone 42, but also through the audio receiving unit 404 of the cell phone 40. In addition, the cell phone 40 can provide users with varied services by the added modules in FIG. 2A to FIG. 2K, for example, a radio intercom function, multi-party conversation with identical or different communication interfaces, watching digital TV, and viewing multimedia information.

When the cell phone 40 combines with the Bluetooth earphone 42 through the card slot 402, the microphone 430 of the Bluetooth earphone 42 will be used as the microphone of the cell phone 40. Beside, the speaker 428 of the Bluetooth earphone 42 will be used as the speaker of the cell phone 40. Thereby, it is not necessary to install a speaker, a microphone, or combination of the both on the cell phone 40, reducing power consumption of the cell phone 40. When the Bluetooth earphone 42 detaches from the card slot 402, the Bluetooth wireless transmission interface between the first wireless module 106 and the second wireless module 126 of the cell phone 40 will be used to make users converse with the Bluetooth earphone 42.

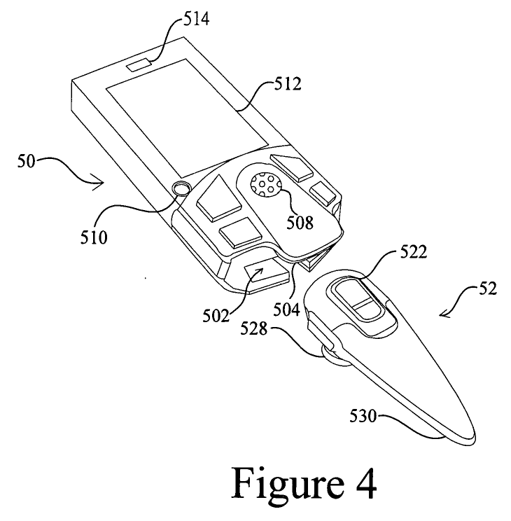

FIG. 4 is a structural schematic diagram according to another preferred embodiment of the present invention. The difference between FIG. 3 and FIG. 4 is that the handheld apparatus in FIG. 3 is a cell phone, while the handheld apparatus in FIG. 4 is a PDA. The handheld apparatus with a detachable audio device according to the present invention can be applied to a PDA 50. A Bluetooth earphone 52 is connected to the PDA 50 through a card slot 502, and is used as an external microphone of the PDA 50. As shown in FIG. 4, the card slot 502, a speaker 508, a web cam 510, a display 512, and an audio receiving unit 514 are adapted to the PDA 50. A first connector 504 is adapted to the card slot 502. A second connector 522, a speaker 528, and a microphone 530 are adapted to the Bluetooth earphone 52. Besides, the Bluetooth earphone 52 can further receive the communication interfaces, such as voice communication of Messenger software, network phones, network video conferences, used by the PDA 50. When the Bluetooth earphone 52 is unavailable, the audio receiving unit 514 of the PDA 50 can be used for inputting voices.

In addition, the microphone 530 of the Bluetooth earphone 52 can be further used as a stylus of the PDA 50. Besides, the combination of the PDA and the Bluetooth earphone 52 can be further applied in notebook computers, so that when a user uses a notebook computer with Bluetooth transmission interface, the user can perform communication operations using the Bluetooth earphone and can process business affaires simultaneously. Moreover, the PDA 50 can provide users with varied services by the added modules in FIG. 2A to FIG. 2K, for example, a radio intercom function, multi-party conversation with identical or different communication interfaces, watching digital TV, and viewing multimedia information.

To sum up, the present invention relates to a handheld apparatus with a detachable audio device. The handheld apparatus connects externally to the audio device through a card slot, so that the audio device can detach from the card slot. A first wireless module and a first connector are adapted to the handheld apparatus, and the first connector is installed inside the card slot. A second connector, an audio input/output module and a second wireless module are adapted to the audio device. By connecting the first connector and the second connector, the handheld apparatus can charge the externally connected audio device. By the wireless transmission between the first wireless module and the second wireless module, users can converse or perform network video conference by using the externally connected audio device. In addition, a multi-party conversation module, an image output device, a multimedia playing device, a digital video control module, a DAB module, a DVB module, a wireless network module, an encryption module, a decryption module, a GPS module, a switching module, or combination of the above modules are adapted to the handheld apparatus to provide varied functionality to users.

Accordingly, the present invention conforms to the legal requirements owing to its novelty, unobviousness, and utility. However, the foregoing description is only a preferred embodiment of the present invention, not used to limit the scope and range of the present invention. Those equivalent changes or modifications made according to the shape, structure, feature, or spirit described in the claims of the present invention are included in the appended claims of the present invention.

1. A handheld apparatus with a detachable audio device, comprising:
a handheld apparatus, including a first wireless module and a first connector, one side of the handheld apparatus having a card slot; and
an audio device, adapted in the card slot of the handheld apparatus, the audio device including an audio input/output module, a second wireless module, and a second connector, and the audio input/output module connecting with the second wireless module;
wherein the audio device and the handheld apparatus transmit signal to each other via the first wireless module and the second wireless module.

2. The handheld apparatus of claim 1, wherein the handheld apparatus further includes an audio input module.

3. The handheld apparatus of claim 1, wherein the handheld apparatus connects to the audio device via the first connector and the second connector for supplying power to the audio device.

4. The handheld apparatus of claim 1, wherein the handheld apparatus is a cell phone.

5. The handheld apparatus of claim 1, wherein the handheld apparatus is a personal digital assistant (PDA).

6. The handheld apparatus of claim 1, wherein the audio device is a Bluetooth wireless earphone.

7. The handheld apparatus of claim 4, wherein the first wireless module and the second wireless module are Bluetooth wireless transmission modules.

8. The handheld apparatus of claim 1, wherein the handheld apparatus further includes a multi-party conversation module.

9. The handheld apparatus of claim 1, wherein the handheld apparatus further includes an image output device.

10. The handheld apparatus of claim 1, wherein the handheld apparatus further includes a multimedia-playing device.

11. The handheld apparatus of claim 1, wherein the handheld apparatus further includes a digital video module.

12. The handheld apparatus of claim 10, wherein the digital video module includes a web cam.

13. The handheld apparatus of claim 1, wherein the handheld apparatus further includes a digital broadcasting module.

14. The handheld apparatus of claim 1, wherein the handheld apparatus further includes a wireless fidelity (WiFi) module.

15. The handheld apparatus of claim 1, wherein the handheld apparatus further includes an encryption module and a decryption module.

16. The handheld apparatus of claim 1, wherein the handheld apparatus further includes a Global Positioning System (GPS) module.

17. The handheld apparatus of claim 1, wherein the handheld apparatus further includes a switching module.

18. The handheld apparatus of claim 1, wherein the handheld apparatus further includes a radio intercom module.

19. The handheld apparatus of claim 1, wherein the handheld apparatus further includes a speech module, which converts incoming phone numbers or identities to a speech signal for providing the handheld apparatus or the audio input/output module of the audio device to play the incoming phone numbers or the identities when a call comes in.
